(19) United States
(12) Patent Application Publication
(10) Pub. No.: US 2008/0093419 A1
(43) Pub. Date: Apr. 24, 2008

(54) Method For Connecting Switch Parts Made of Austenitic Manganese Steel Casting, or Austenitic Manganese Steel Rails, With a Rail of Carbon Steel

(75) Inventors: Erik Stocker, Lois-Hammer-Gasse (AT); Heinz Ossberger, Mursiedlung (AT)

Correspondence Address: CHAPMAN AND CUTLER, 111 WEST MONROE STREET, CHICAGO, IL, 60603, US

(73) Assignees: VAE Eisenbahnsysteme GmbH, Zeltweg (AT); VAE GmbH, Vienna (AT)

(21) Appl. No.: 11/792,468

(22) PCT Filed: Dec. 2, 2005
(86) PCT No.: PCT/AT05/00487

§ 371 Date: Jun. 6, 2007

(30) Foreign Application Priority Data
Dec. 10, 2004 (AT) A 2085/2004

(51) Int. Cl. B23K 20/12

(52) U.S. Cl. 228/112.1

(57) ABSTRACT

In a method for connecting switch or crossing parts made of austenitic manganese steel casting, or austenitic manganese steel rails, with rails of carbon steel, the parts to be connected, optionally upon interposition of an intermediate piece, are connected by friction welding, wherein the weld with the austenitic manganese steel is cooled at static air without heat treatment.

The invention relates to a method for connecting switch or crossing parts made of austenitic manganese steel casting, or austenitic manganese steel rails, with rails of carbon steel.

To connect cross frogs made of austenitic manganese steel with standard rails, it has already been proposed in AT 350881 B as well as in DE 2834282 A to realize a flash butt weld, by which an intermediate piece is connected with a standard rail. According to that prior proposal, the intermediate piece was, therefore, cut to a maximum length of 20 to 25 mm, whereupon the connection of the intermediate piece with the austenitic manganese steel casting cross frog was effected by a further flash butt weld. That second welding procedure called for more rapid cooling than after the first welding procedure, whereby slower cooling served to avoid an increase in the hardening of the rail steel. The use of an intermediate piece was above all necessary because alloying elements diffused into the carbon steel of the standard rail during those welding procedures, which resulted in unprecisely defined textures entailing increased risks of fracture. Intermediate pieces, on the other hand, are to be taken as substantially softer than austenitic manganese steel casting and, consequently, subject to elevated wear. Austenitic steels as proposed for such intermediate pieces are, therefore, less resistant to wear than the material of the cross frog such that dents have been observed on the upper surface of the intermediate piece with intermediate pieces of too great a length. If, on the other hand, the intermediate piece is chosen too short, this will again entail the risk of the alloying elements diffusing from the austenitic manganese steel into the carbon steel. The intermediate pieces, thus, serve to separate the two welds in thermal respect in order to be able to keep to the respectively required cooling conditions on the respective welds and avoid embrittlements. Such embrittlements of austenitic manganese steel casting in the first place are due to diffusion effects, whereas carbon steel can be accordingly soft-cooled by the temperature of flash butt welding.

A method for producing a connection between a rail of manganese steel casting and a rail of plain carbon steel is to be taken from EP 0070774 A, wherein a special alloy is to be used for the manganese steel casting rail part. For such connections between an austenitic manganese steel and a steel workpiece, also aluminothermal melts and the casting of a thus obtained metal between two rail parts placed in a mold in a spaced-apart relationship have already been proposed in EP 181251 A. In AT 395122 B, an intermediate piece of an austenitic, low-carbon steel stabilized with niobium and/or titanium was proposed, with a chromium-nickel steel having been used in particular, whereby also there a thermal treatment was required following the first welding operation between the intermediate piece and the standard rail, to which end a homogenization at temperatures of between 350° and 1000° C. was proposed in particular.

The invention aims to provide a method of the initially defined kind, which will do with substantially shorter intermediate pieces, wherein, in a preferred manner, the use of intermediate pieces may be renounced at all. To solve this object, the method according to the invention essentially consists in that the parts to be connected, optionally upon interposition of an intermediate piece, are connected by friction welding, wherein the weld with the austenitic manganese steel is cooled at static air without heat treatment. It has now been found in a surprising manner that by the application of a friction welding process the thermal load on the welds, as compared with other known welding processes, can be reduced to such an extent that diffusion procedures will be minimized and undesired thermal shifts will be eliminated almost completely. By employing friction welding as a method for producing said connection, the interposition of an intermediate piece can be totally renounced without requiring a separate heat treatment following the welding operation. The only heat treatment optionally required, which is actually not to be addressed as a heat treatment, would consist in preheating the standard rail in order to be able to readily attain the temperatures required to make the weld. It is in any event feasible to allow the welding joint to cool at static air, even without the interposition of an intermediate piece, and without heat treatment, the method thus being substantially simplified over known methods.

In a preferred manner, when using an intermediate piece, it is proceeded according to the invention in that an optionally effected heat treatment, or delayed cooling, is limited to the weld made between the carbon steel and the intermediate piece. However, such a heat treatment after having made the first weld, i.e., that between the rail and the intermediate piece, may, as a rule, be likewise omitted if a friction welding process is employed.

A thermal aftertreatment after the realization of the weld with the austenitic manganese steel is not necessary for sure. Merely may the preheating of the standard rails for the friction welding process turn out to be advantageous.

In the main, expensive heat treatments may, thus, be renounced in a particularly simple manner by using known friction welding processes as may be taken, for instance, from EP 1459833 A1 or WO 2004/028733 A1, whereby the negative side effects of known welding processes will surprisingly be eliminated even without the use of intermediate pieces, and the formation of soft-annealed zones which may lead to dents will be avoided.

1-2. (canceled)

3. A method for connecting a switch or crossing part made of austenitic manganese steel casting with a carbon steel rail, comprising the step of connecting the switch or crossing part made of austenitic manganese steel casting with the carbon steel rail by friction welding, wherein the weld is cooled at static air without heat treatment.

4. A method according to claim 3, further comprising the step of interposing an intermediate piece between the switch or crossing part made of austenitic manganese steel casting and the carbon steel rail, prior to the friction welding.

5. A method according to claim 4, further comprising the step of
heat treating or delayed cooling of the weld, wherein
said heat treatment or delayed cooling is limited to the weld made between the carbon steel rail and the intermediate piece.

6. A method for connecting an austenitic manganese steel rail with a carbon steel rail, comprising the step of
connecting the austenitic manganese steel rail with the carbon steel rail by friction welding, wherein
the weld is cooled at static air without heat treatment.

7. A method according to claim 6, further comprising the step of
interposing an intermediate piece between the austenitic manganese steel rail and the carbon steel rail, prior to the friction welding.

8. A method according to claim 7, further comprising the step of
heat treating or delayed cooling of the weld, wherein
said heat treatment or delayed cooling is limited to the weld made between the carbon steel rail and the intermediate piece.
